(19) United States
(12) Patent Application Publication
(10) Pub. No.: US 2018/0279630 A1
(43) Pub. Date: Oct. 4, 2018

(54) METHOD FOR THE PRODUCTION AND PRESERVATION OF AN ARTISANAL NEAPOLITAN PIZZA

(71) Applicant: VULCANO FOOD GOURMET S.R.L., Napoli (IT)

(72) Inventor: Maurizio RAMIREZ, Napoli (IT)

(21) Appl. No.: 15/545,257

(22) PCT Filed: Jan. 14, 2016
(86) PCT No.: PCT/IB2016/050165

§ 371 Date: Jul. 20, 2017

(30) Foreign Application Priority Data
Jan. 21, 2015 (IT) BS2015A000007

(51) Int. Cl. A21D 15/02; A21D 13/41; B65B 25/00

(52) U.S. Cl. CPC A21D 15/02; B65B 25/001; A21D 13/41

(57) ABSTRACT

A method for the preparation and preservation of an artisanal Neapolitan pizza includes the steps of making a hand-crafted raw pizza, baking it in an oven and subjecting the cooked pizza to cryogenic reduction. The pizza may be subsequently vacuum packed. The pizza may be made with high quality traditional ingredients.

The present invention relates to a method for the production and preservation of a pizza.

As known, traditional Neapolitan pizza is among the world's most popular foods, although prepared and consumed using extremely varied methods.

Artisanal Neapolitan pizza is prepared by hand in pizzerias and consumed immediately on site or, if takeaway, at home; numerous catering establishments however, not having an oven and the necessary staff, such as cafés and fast food restaurants, use industrial frozen pizzas, which are heated when needed. Lastly, there are numerous industrial frozen pizzas sold at the supermarket, which can be stored in the freezer and baked when needed.

The difference in taste and aroma between the artisanal pizza and industrial ones is obvious to all.

The purpose of the present invention is to provide a method for the production of artisanal pizza and its preservation.

Such purpose is achieved by a method according to claim 1. The dependent claims describe embodiment variants of the method.

The characteristics and advantages of the method according to the present invention will be evident from the description below, made by way of a non-limiting example.

According to the invention, the production method provides for the step of making a dough, mixing by hand or in a mixer, several ingredients, preferably in the quantities established by the international regulations for obtaining the collective trademark “verace pizza napoletana” (genuine Neapolitan pizza) of the Associazione Verace Pizza Napoletana.

Said ingredients comprise:
flour, wheat flour or organic, preferably produced by slow grinding, from wheat milled in Italy;
water, coming from springs in Campania (Italy), characterized by a high limestone content;
sea salt;
sourdough.

When the dough has reached the desired consistency and pliablity, it is cut by hand and each portion is placed in a proofing drawer.

The method subsequently provides for the proofing step, during which the portions of dough are kept in a temperature controlled environment, typically variable from 20 to 22° C., for a long period of time, for example at least 24 hours. Long and slow proofing is thus achieved.

After the proofing, each portion of dough has become a slab of dough which is subsequently kneaded by hand, rolled out by hand and made to rotate on a rigid surface, usually marble, dusted with flour. A base is thus made from each slab, having the traditional shape with thicker edges, of a suitable size, usually between 25-30 centimetres.

The base is then topped with:
tomato puree, preferably D.O.P San Marzano Nocerino Sarnese, with a particular taste due to the potassium content, or organic;
extra-virgin olive oil made in Italy, for example organic;
mozzarella, preferably made from fresh cow's milk 100% produced in Campania (Italy), or mozzarella D.O.P. made from 100 percent buffalo milk, produced in Campania (Italy).

The raw pizza thus obtained is placed by the pizza maker on a shovel and inserted in a traditional, preferably wood oven, for cooking.

Cooking preferably takes place at a constant temperature, typically between 450°-500° C., preferably at 480° C. The cooking time in the oven is generally between 50 to 120 seconds, preferably between 60 and 90 seconds.

The pizza maker rotates the pizza while cooking as needed so as to bring the different portions of the pizza to the side of the flame.

Once cooked, the pizza, extracted from the oven with the shovel and placed on a conveyor belt, is suddenly subjected a cryogenic reduction, for example, passing through a liquid nitrogen cooled tunnel.

Usually, the pizza enters the reduction tunnel at a temperature between 70° C. and 90° C., preferably between 70° C. and 80° C., and comes out after an interval of time of between 10 and 14 minutes, preferably 12 minutes, and presents on coming out a temperature between −20° C. and −15° C., preferably −18° C. at the heart of the pizza.

After being subjected to cryogenic reduction, the pizza is vacuum packed, i.e. so that the packaging around it is air-tight, and stored in a refrigerated cell, usually at a temperature between −25° C. and −15° C., preferably between −20° C. and −18° C.

For the shipment of the preserved pizzas, refrigerated trucks are used or, for shipments to remote places, refrigerated and insulated containers.

To prepare the pizza for eating, various procedures may be adopted.

For home preparation, an electric oven can be used, preheated to a temperature between 180° C. and 220° C., preferably 200° C.; the pizza is placed on a grill in the lower part of the oven, for an interval of time between 6 and 9 minutes, preferably between 7 and 8 minutes.

Alternatively, the pizza can be thawed in a microwave oven for about 2 minutes, and then cooked in the oven, under the same conditions as above, for 4 or 5 minutes.

Alternatively again, the pizza can be thawed at room temperature, for example for 20 minutes, and then cooked in the oven, in the aforesaid manner , for 4-5 minutes.

For professional preparation in catering establishments, the pizza is prepared in a pizza oven with a refractory brick counter. The strong thermal shock in any case ensures greater softness.

Innovatively, the method described above makes it possible to savour a pizza with the taste and smell of an artisanal pizza, even though preserved; cryogenic reduction, in fact, instantly blocks all organic degeneration processes.

Advantageously, moreover, the vacuum preservation makes it possible to isolate the pizza from the surrounding environment. This is especially appreciated, for example, for storage in the freezer, both at home and in commercial establishments, so it does not absorb the odours of other foods stored therein.

According to a further advantageous aspect, the ingredients used for the production of the pizza are those specified by the regulations and some of them are from Campania (Italy), such as the flour, the water, the tomatoes and the mozzarella. It is well known that the organoleptic characteristics of these give the pizza a particular taste, better than similar artisanal pizzas made with generic ingredients.

It is clear that a person skilled in the art may make modifications to the method described above so as to satisfy contingent requirements ,all contained within the scope of protection as defined by the following claims.

1. Method for the preparation and preservation of a genuine Neapolitan pizza, comprising the steps of:
making a hand-crafted raw pizza,
baking the raw pizza in an oven until the pizza is cooked and
removing the cooked pizza from the oven and subjecting the cooked pizza to a cryogenic reduction.

2. Method according to claim 1, wherein for the cryogenic reduction, the pizza remains for an interval of time comprised between 10 and 14 minutes, at a low temperature and at the end of the procedure has a temperature of between −20° C. and −15° C. in a centre of the pizza.

3. Method according to claim 1, wherein for the cryogenic reduction the pizza passes through a liquid nitrogen-cooled tunnel.

4. Method according to claim 1, wherein, after having been subjected to cryogenic reduction, the pizza is vacuum-packed.

5. Method according to claim 4 wherein the vacuum packaged pizza is kept in a refrigerated cell, at a temperature between −25° C. and −15° C.

6. Method according to claim 1, wherein the step of producing the hand-crafted raw pizza comprises the step of kneading the flour, water, sea salt and yeast, in which the dough is made by hand or using a kneading machine.

7. Method according to claim 6 wherein the flour is wheat or organic flour, made by slow grinding, from wheat ground in Italy and the water is taken from springs in Campania (Italy).

8. Method according to claim 6 wherein the dough is cut by hand and each portion is placed in a proofing drawer.

9. Method according to claim 8, wherein the portions of dough are subjected to a proofing step.

10. Method according to claim 9, wherein during the proofing step, the portions of dough are kept in a temperature controlled environment, from 20 to 22° C., for at least 24 hours.

11. Method according to claim 9, wherein, after the proofing, each portion of dough has become a slab of dough which is subsequently kneaded by hand, rolled out by hands and made to rotate on a rigid surface, obtaining a disc base.

12. Method according to claim 11, wherein the base is then topped with tomato puree, extra-virgin olive oil and mozzarella.

13. Method according to claim 12, wherein the tomatoes are the San Marzano DOP Nocerino-Sarnese, or organic type; the extra-virgin olive oil is made in Italy; the mozzarella is made from fresh cow's milk 100% produced in Campania (Italy), or is mozzarella D.O.P. made from 100 percent buffalo milk, produced in Campania (Italy).

14. Method according to claim 1, wherein the raw pizza is placed by the pizza maker on a shovel and inserted in a traditional wood oven, for cooking.

15. Method according to claim 14, wherein cooking takes place at a constant temperature, typically between 450°-500° C., and the baking time in the oven is between 50 to 120 seconds.

16. Method according to claim 15, wherein during the baking, the pizza maker rotates the pizza cooking so as to bring the different portions of the pizza to the side of the flame.

17. Traditional Neapolitan pizza cryogenically reduced.

18. Pizza according to claim 17, vacuum packed.

19. Pizza according to claim 17, made with the following ingredients:
flour, wheat flour or organic, from wheat milled in Italy;
water, coming from springs in Campania (Italy), comprising a high limestone content;
sea salt;
sourdough;
tomato puree;
extra-virgin olive oil made in Italy;
mozzarella.

20. A method of producing a traditional Neapolitan pizza according to claim 17, comprising using a pizza oven with refractory brick counter for professional preparation in catering establishments.

21. A traditional Neapolitan pizza, obtained by the method according to claim 1 in a pizza oven with refractory brick counter for professional preparation in catering establishments.

22. A pizza according to claim 19, wherein the mozzarella is made from fresh cow's milk 100% produced in Campania (Italy).

23. A pizza according to claim 19, wherein the mozzarella is mozzarella D.O.P. made from 100 percent buffalo milk, produced in Campania (Italy).

24. A pizza according to claim 19, wherein the tomato puree is D.O.P San Marzano Nocerino-Sarnese tomato puree.

25. A pizza according to claim 19, wherein the tomato puree is organic tomato puree.
